(19) United States
(12) Patent Application Publication
(10) Pub. No.: US 2015/0356833 A1
(43) Pub. Date: Dec. 10, 2015

(54) Wagering Game With Symbols Accrual Determining Bonus Award Upon Triggering Event

(71) Applicant: WMS Gaming Inc, Waukegan, IL (US)

(72) Inventors: Dion K. Aoki, Santa Monica, CA (US); Andrew C. Guinn, Chicago, IL (US); Jeremy M. Hornik, Chicago, IL (US); Joel R. Jaffe, Glenview, IL (US)

(21) Appl. No.: 14/733,623

(22) Filed: Jun. 8, 2015

Related U.S. Application Data
(60) Provisional application No. 62/009,462, filed on Jun. 9, 2014.

(51) Int. Cl. G07F 17/34; G07F 17/32

(52) U.S. Cl. CPC G07F 17/34; G07F 17/3216; G07F 17/3225

(57) ABSTRACT

A gaming system includes a gaming cabinet, an electronic display device, one or more electronic input devices, and game-logic circuitry that initiates a casino wagering game in response to a wager input and that randomly selects a plurality of symbols arranged in an array. The array includes at least one trigger symbol and a plurality of non-trigger symbols, including first and second non-trigger symbols. In response to the trigger symbol being randomly selected, a bonus enhancement is determined based on an accrued number of the first non-trigger symbols within the array. An initial award is awarded based on an aggregated value of the second non-trigger symbols. A final award is awarded by enhancing the initial award with the bonus enhancement.

### CROSS-REFERENCE TO RELATED APPLICATIONS

This application claims the benefit of and priority to U.S. Provisional Patent Application No. 62/009,462 titled “Wagering Game With Symbols Accrual Determining Bonus Award Upon Triggering Event” and filed on Jun. 9, 2014, which is incorporated herein by reference in its respective entirety.

### COPYRIGHT

A portion of the disclosure of this patent document contains material which is subject to copyright protection. The copyright owner has no objection to the facsimile reproduction by anyone of the patent disclosure, as it appears in the Patent and Trademark Office patent files or records, but otherwise reserves all copyright rights whatsoever.

### FIELD OF THE INVENTION

The present invention relates generally to gaming apparatus and methods and, more particularly, to non-trigger symbols determining bonus enhancements independently of a triggering condition.

### BACKGROUND OF THE INVENTION

Gaming machines, such as slot machines, video poker machines and the like, have been a cornerstone of the gaming industry for several years. Generally, the popularity of such machines with players is dependent on the likelihood (or perceived likelihood) of winning money at the machine and the intrinsic entertainment value of the machine relative to other available gaming options. Where the available gaming options include a number of competing machines and the expectation of winning at each machine is roughly the same (or believed to be the same), players are likely to be attracted to the most entertaining and exciting machines. Shrewd operators consequently strive to employ the most entertaining and exciting machines, features, and enhancements available because such machines attract frequent play and hence increase profitability to the operator. Therefore, there is a continuing need for gaming machine manufacturers to continuously develop new games and improved gaming enhancements that will attract frequent play through enhanced entertainment value to the player.

### SUMMARY OF THE INVENTION

According to one aspect of the present invention, a gaming system includes input devices, display devices, and game-logic circuitry that receives an input indicative of a wager and randomly selects a plurality of symbols arranged in an array. The array includes at least one trigger symbol and a plurality of non-trigger symbols, including first and second non-trigger symbols. In response to the trigger symbol being randomly selected, a bonus enhancement is determined based on an accrued number of the first non-trigger symbols within the array. An initial award is awarded based on an aggregated value of the second non-trigger symbols. A final award is awarded by enhancing the initial award with the bonus enhancement.

According to another aspect of the invention, a computer-implemented method in a gaming system having game-logic circuitry includes one or more central processing units and one or more memory devices. The method includes receiving, via at least one of one or more input devices, an input indicative of a wager, and displaying, on at least one of one or more display devices, a plurality of symbols arranged in an array. The method further includes randomly selecting, by the game-logic circuitry, at least one trigger symbol and a plurality of non-trigger symbols. In response to the at least one trigger symbol being randomly selected, a bonus enhancement is determined, by the game-logic circuitry, based on an accrued number of first non-trigger symbols within the array. An initial award is awarded, by the game-logic circuitry, based on an aggregated value of the second non-trigger symbols, A final award is awarded, by the game-logic circuitry by enhancing the initial award with the bonus enhancement.

According to yet another aspect of the invention, one or more physical machine-readable non-transitory storage media includes instructions that, when executed by one or more processors, cause the one or more processors to perform operations including receiving, via at least one of one or more input devices, an input indicative of a wager. A plurality of symbols arranged in an array are displayed on at least one of one or more display devices. At least one trigger symbol and a plurality of non-trigger symbols are randomly selected by at least one of the one or more processors. The plurality of non-trigger symbols includes one or more first non-trigger symbols and one or more second non-trigger symbols. In response to the at least one trigger symbol being randomly selected, a bonus enhancement is determined, by at least one of the one or more processors, based on an accrued number of first non-trigger symbols within the array. An initial award is awarded, by at least one of the one or more processors, based on an aggregated value of the second non-trigger symbols, A final award is awarded, by at least one of the one or more processors, by enhancing the initial award with the bonus enhancement.

According to still another aspect of the invention, the above gaming system is incorporated into a single, free-standing gaming terminal.

Additional aspects of the invention will be apparent to those of ordinary skill in the art in view of the detailed description of various embodiments, which is made with reference to the drawings, a brief description of which is provided below.

### BRIEF DESCRIPTION OF THE DRAWINGS

FIG. 1 is a perspective view of a free-standing gaming machine according to an embodiment of the present invention.

FIG. 2 is a schematic view of a gaming system according to an embodiment of the present invention.

FIG. 3 is an image of an exemplary basic-game screen of a wagering game displayed on a gaming machine, according to an embodiment of the present invention.

FIG. 4 is an image of a wagering game in which a bonus game is triggered.

FIG. 5 is an image of the bonus game triggered in FIG. 4 in which first non-trigger symbols are accrued for determining a multiplier value.

FIG. 6 is an image of the bonus game of FIG. 5 in which a single bonus award base value is randomly determined for second non-trigger symbols.

FIG. 7 is an image of the bonus game of FIG. 6 in which values of the second non-trigger symbols are accrued.

FIG. 8 is an image of the bonus game of FIG. 7 in which a final total value is determined based on the accrued first and second non-trigger symbols.

FIG. 9 is an image of a bonus array in which surrounding symbols provide an additional benefit.

FIG. 10 is an image of a bonus array in which a qualifying condition is required, in response to a trigger condition, for determining a bonus enhancement.

FIG. 11 is an image of a bonus array in which non-trigger special-count symbols determine a bonus enhancement based on array sections.

FIG. 12 is a flowchart for an algorithm that corresponds to instructions executed by a controller in accord with at least some aspects of the disclosed concepts.

While the invention is susceptible to various modifications and alternative forms, specific embodiments have been shown by way of example in the drawings and will be described in detail herein. It should be understood, however, that the invention is not intended to be limited to the particular forms disclosed. Rather, the invention is to cover all modifications, equivalents, and alternatives falling within the spirit and scope of the invention as defined by the appended claims.

### DETAILED DESCRIPTION

While this invention is susceptible of embodiment in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated. For purposes of the present detailed description, the singular includes the plural and vice versa (unless specifically disclaimed); the words “and” and “or” shall be both conjunctive and disjunctive; the word “all” means “any and all”; the word “any” means “any and all”; and the word “including” means “including without limitation.”

For purposes of the present detailed description, the terms “wagering games,” “gambling,” “slot game,” “casino game,” and the like include games in which a player places at risk a sum of money or other representation of value, whether or not redeemable for cash, on an event with an uncertain outcome, including without limitation those having some element of skill. In some embodiments, the wagering game may involve wagers of real money, as found with typical land-based or on-line casino games. In other embodiments, the wagering game may additionally, or alternatively, involve wagers of non-cash values, such as virtual currency, and therefore may be considered a social or casual game, such as would be typically available on a social networking web site, other web sites, across computer networks, or applications on mobile devices (e.g., phones, tablets, etc.). When provided in a social or casual game format, the wagering game may closely resemble a traditional casino game, or it may take another form that more closely resembles other types of social/casual games.

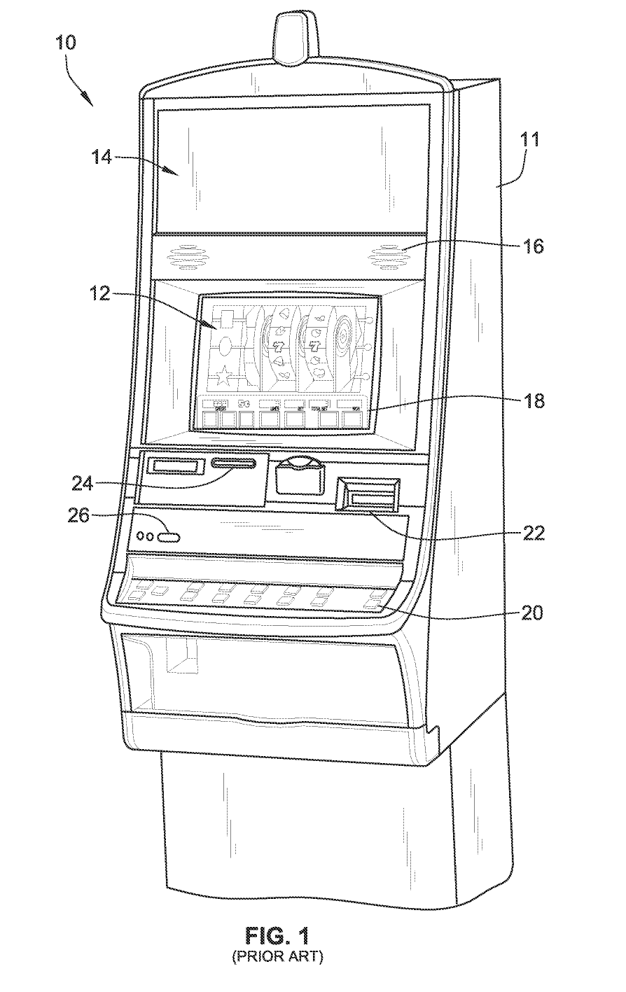

Referring to FIG. 1, there is shown a gaming machine 10 similar to those used in gaming establishments, such as casinos. With regard to the present invention, the gaming machine 10 may be any type of gaming terminal or machine and may have varying structures and methods of operation. For example, in some aspects, the gaming machine 10 is an electromechanical gaming terminal configured to play mechanical slots, whereas in other aspects, the gaming machine is an electronic gaming terminal configured to play a video casino game, such as slots, keno, poker, blackjack, roulette, craps, etc. The gaming machine 10 may take any suitable form, such as floor-standing models as shown, handheld mobile units, bartop models, workstation-type console models, etc. Further, the gaming machine 10 may be primarily dedicated for use in conducting wagering games, or may include non-dedicated devices, such as mobile phones, personal digital assistants, personal computers, etc. Exemplary types of gaming machines are disclosed in U.S. Pat. No. 6,517,433 and Patent Application Publication Nos. US2010/0069160 and US2010/0234099, which are incorporated herein by reference in their entireties.

The gaming machine 10 illustrated in FIG. 1 comprises a cabinet 11 that may house various input devices, output devices, and input/output devices. By way of example, the gaming machine 10 includes a primary display area 12, a secondary display area 14, and one or more audio speakers 16. The primary display area 12 or the secondary display area 14 may be a mechanical-reel display, a video display, or a combination thereof in which a transmissive video display is disposed in front of the mechanical-reel display to portray a video image superimposed upon the mechanical-reel display. The display areas may variously display information associated with wagering games, non-wagering games, community games, progressives, advertisements, services, premium entertainment, text messaging, emails, alerts, announcements, broadcast information, subscription information, etc. appropriate to the particular mode(s) of operation of the gaming machine 10. The gaming machine 10 includes a touch screen(s) 18 mounted over the primary or secondary areas, buttons 20 on a button panel, bill validator 22, information reader/writer(s) 24, and player-accessible port(s) 26 (e.g., audio output jack for headphones, video headset jack, USB port, wireless transmitter/receiver, etc.). It should be understood that numerous other peripheral devices and other elements exist and are readily utilizable in any number of combinations to create various forms of a gaming machine in accord with the present concepts.

Input devices, such as the touch screen 18, buttons 20, a mouse, a joystick, a gesture-sensing device, a voice-recognition device, and a virtual-input device, accept player input(s) and transform the player input(s) to electronic data signals indicative of the player input(s), which correspond to an enabled feature for such input(s) at a time of activation (e.g., pressing a “Max Bet” button or soft key to indicate a player's desire to place a maximum wager to play the wagering game). The input(s), once transformed into electronic data signals, are output to a game-logic circuitry for processing. The electronic data signals are selected from a group consisting essentially of an electrical current, an electrical voltage, an electrical charge, an optical signal, an optical element, a magnetic signal, and a magnetic element.

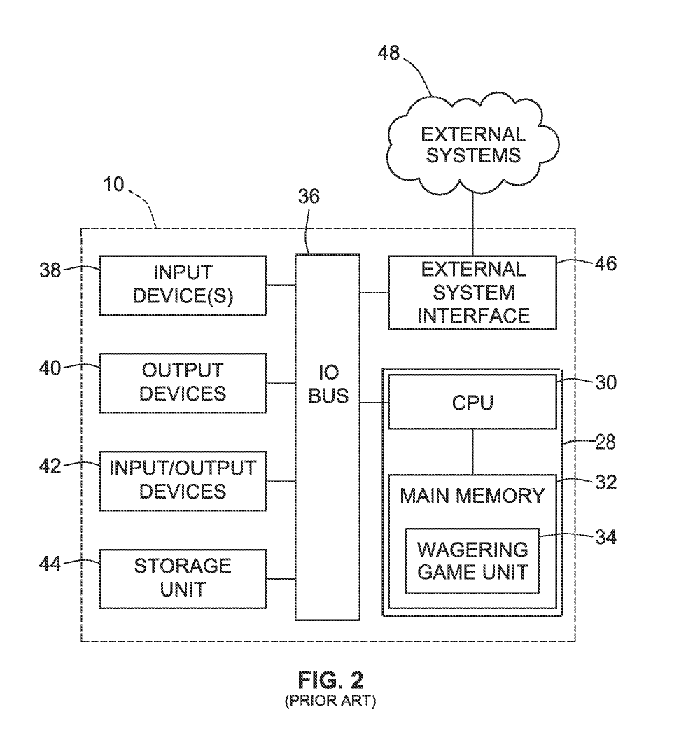

Turning now to FIG. 2, there is shown a block diagram of the gaming-machine architecture. The gaming machine 10 includes game-logic circuitry 28 having a central processing unit (CPU) 30 connected to a main memory 32. The CPU 30 may include any suitable processor(s), such as those made by Intel and AMD. By way of example, the CPU 30 may include a plurality of microprocessors including a master processor, a slave processor, and a secondary or parallel processor. Game-logic circuitry 28, as used herein, comprises any combination of hardware, software, or firmware disposed in or outside of the gaming machine 10 that is configured to communicate with or control the transfer of data between the gaming machine 10 and a bus, another computer, processor, device, service, or network. The game-logic circuitry 28, and more specifically the CPU 30, comprises one or more controllers or processors and such one or more controllers or processors need not be disposed proximal to one another and may be located in different devices or in different locations. The game-logic circuitry 28, and more specifically the main memory 32, comprises one or more memory devices which need not be disposed proximal to one another and may be located in different devices or in different locations. The game-logic circuitry 28 is operable to execute all of the various gaming methods and other processes disclosed herein. The main memory 32 includes a wagering-game unit 34. In one embodiment, the wagering-game unit 34 may cause wagering games to be presented, such as video poker, video black jack, video slots, video lottery, etc., in whole or part.

The game-logic circuitry 28 is also connected to an input/output (I/O) bus 36, which can include any suitable bus technologies, such as an AGTL+ frontside bus and a PCI backside bus. The I/O bus 36 is connected to various input devices 38, output devices 40, and input/output devices 42 such as those discussed above in connection with FIG. 1. The I/O bus 36 is also connected to a storage unit 44 and an external-system interface 46, which may be connected to external system(s) 48 (e.g., wagering-game networks).

The external system 48 includes, in various aspects, a gaming network, other gaming machines or terminals, a gaming server, a remote controller, communications hardware, or a variety of other interfaced systems or components, in any combination. In yet other aspects, the external system 48 may comprise a player's portable electronic device (e.g., cellular phone, electronic wallet, etc.) and the external-system interface 46 is configured to facilitate wireless communication and data transfer between the portable electronic device and the gaming machine 10, such as by a near-field communication path operating via magnetic-field induction or a frequency-hopping spread spectrum RF signals (e.g., Bluetooth, etc.).

The gaming machine 10 optionally communicates with the external system 48 such that the gaming machine 10 operates as a thin, thick, or intermediate client. The game-logic circuitry 28—whether located within (“thick client”), external to (“thin client”), or distributed both within and external to (“intermediate client”) the gaming machine 10—is utilized to provide a wagering game on the gaming machine 10. In general, the main memory 32 (comprising one or more memory devices) stores programming for an RNG, game-outcome logic, and game assets (e.g., art, sound, etc.). When a wagering-game instance is executed, the CPU 30 (comprising one or more processors or controllers) executes the RNG programming to generate one or more pseudo-random numbers. The pseudo-random numbers are utilized by the CPU 30 when executing the game-outcome logic to determine a resultant outcome for that instance of the wagering game. The resultant outcome is then presented to a player of the gaming machine 10 by accessing the associated game assets, required for the resultant outcome, from the main memory 32. The CPU 30 causes the game assets to be presented to the player as outputs from the gaming machine 10 (e.g., audio and video presentations).

The gaming machine 10 may include additional peripheral devices or more than one of each component shown in FIG. 2. Any component of the gaming-machine architecture may include hardware, firmware, or tangible machine-readable storage media including instructions for performing the operations described herein. Machine-readable storage media includes any mechanism that stores information and provides the information in a form readable by a machine (e.g., gaming terminal, computer, etc.). For example, machine-readable storage media includes read only memory (ROM), random access memory (RAM), magnetic-disk storage media, optical storage media, flash memory, etc.

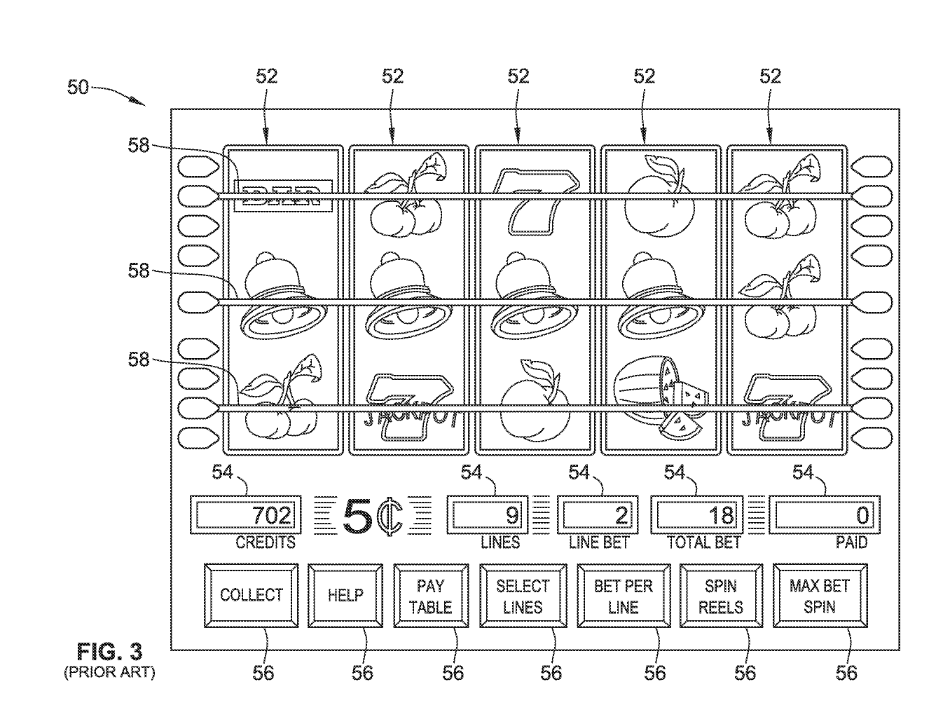

Referring now to FIG. 3, there is illustrated an image of a basic-game screen 50 adapted to be displayed on the primary display area 12 or the secondary display area 14. The basic-game screen 50 portrays a plurality of simulated symbol-bearing reels 52. Alternatively or additionally, the basic-game screen 50 portrays a plurality of mechanical reels or other video or mechanical presentation consistent with the game format and theme. The basic-game screen 50 also advantageously displays one or more game-session credit meters 54 and various touch screen buttons 56 adapted to be actuated by a player. A player can operate or interact with the wagering game using these touch screen buttons or other input devices such as the buttons 20 shown in FIG. 1. The game-logic circuitry 28 operates to execute a wagering-game program causing the primary display area 12 or the secondary display area 14 to display the wagering game.

In response to receiving an input indicative of a wager, the reels 52 are rotated and stopped to place symbols on the reels in visual association with paylines such as paylines 58. The wagering game evaluates the displayed array of symbols on the stopped reels and provides immediate awards and bonus features in accordance with a pay table. The pay table may, for example, include “line pays” or “scatter pays.” Line pays occur when a predetermined type and number of symbols appear along an activated payline, typically in a particular order such as left to right, right to left, top to bottom, bottom to top, etc. Scatter pays occur when a predetermined type and number of symbols appear anywhere in the displayed array without regard to position or paylines. Similarly, the wagering game may trigger bonus features based on one or more bonus triggering symbols appearing along an activated payline (i.e., “line trigger”) or anywhere in the displayed array (i.e., “scatter trigger”). The wagering game may also provide mystery awards and features independent of the symbols appearing in the displayed array.

In accord with various methods of conducting a wagering game on a gaming system in accord with the present concepts, the wagering game includes a game sequence in which a player makes a wager and a wagering-game outcome is provided or displayed in response to the wager being received or detected. The wagering-game outcome, for that particular wagering-game instance, is then revealed to the player in due course following initiation of the wagering game. The method comprises the acts of conducting the wagering game using a gaming apparatus, such as the gaming machine 10 depicted in FIG. 1, following receipt of an input from the player to initiate a wagering-game instance. The gaming machine 10 then communicates the wagering-game outcome to the player via one or more output devices (e.g., primary display 12 or secondary display 14) through the display of information such as, but not limited to, text, graphics, static images, moving images, etc., or any combination thereof. In accord with the method of conducting the wagering game, the game-logic circuitry 28 transforms a physical player input, such as a player's pressing of a “Spin Reels” touch key, into an electronic data signal indicative of an instruction relating to the wagering game (e.g., an electronic data signal bearing data on a wager amount).

In the aforementioned method, for each data signal, the game-logic circuitry 28 is configured to process the electronic data signal, to interpret the data signal (e.g., data signals corresponding to a wager input), and to cause further actions associated with the interpretation of the signal in accord with stored instructions relating to such further actions executed by the controller. As one example, the CPU 30 causes the recording of a digital representation of the wager in one or more storage media (e.g., storage unit 44), the CPU 30, in accord with associated stored instructions, causes the changing of a state of the storage media from a first state to a second state. This change in state is, for example, effected by changing a magnetization pattern on a magnetically coated surface of a magnetic storage media or changing a magnetic state of a ferromagnetic surface of a magneto-optical disc storage media, a change in state of transistors or capacitors in a volatile or a non-volatile semiconductor memory (e.g., DRAM), etc. The noted second state of the data storage media comprises storage in the storage media of data representing the electronic data signal from the CPU 30 (e.g., the wager in the present example). As another example, the CPU 30 further, in accord with the execution of the stored instructions relating to the wagering game, causes the primary display 12, other display device, or other output device (e.g., speakers, lights, communication device, etc.) to change from a first state to at least a second state, wherein the second state of the primary display comprises a visual representation of the physical player input (e.g., an acknowledgement to a player), information relating to the physical player input (e.g., an indication of the wager amount), a game sequence, an outcome of the game sequence, or any combination thereof, wherein the game sequence in accord with the present concepts comprises acts described herein. The aforementioned executing of the stored instructions relating to the wagering game is further conducted in accord with a random outcome (e.g., determined by the RNG) that is used by the game-logic circuitry 28 to determine the outcome of the wagering-game instance. In at least some aspects, the game-logic circuitry is configured to determine an outcome of the wagering-game instance at least partially in response to the random parameter.

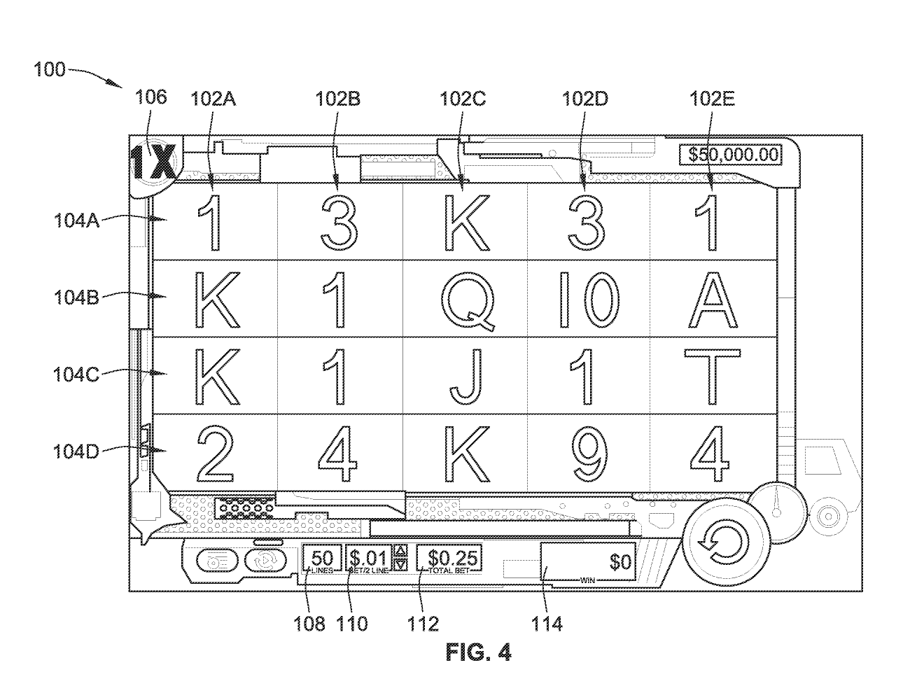

Referring generally now to FIGS. 4-12, a wagering game includes a bonus game triggered during play of a basic game. During the basic game, non-trigger symbols are located within an array for determining bonus enhancements when a separate, independent triggering condition occurs during that play. In other words, the non-trigger symbols determine bonus enhancements independent from the trigger symbols. In a specific example, an accrued number of non-trigger symbols determines bonus enhancements in response to a triggering condition that causes a bonus game. Thus, while conducting a basic game, a bonus trigger occurs and causes a bonus game, the characteristics of which are determined, at least in part, by the non-trigger symbols displayed within the basic-game array.

By way of another specific example, a bonus enhancement is determined based on a number of accrued non-trigger symbols of a first category. A symbol value is selected for each symbol of a second category of non-trigger symbols based on the number and/or type of the first-category symbols. An initial award is determined based on an aggregated value of the second-category symbols. The bonus enhancement is applied to the initial award, resulting in a final award.

Wagering Game with Accrual of Symbols

In reference to the exemplary game of FIG. 4, an illustrated image of a wagering game screen 100 is adapted to be displayed on the main display area 12 or the secondary display area 14. The game screen 100 portrays an array arranged in the form of a plurality of symbol-bearing reels, which include a first reel 102A, a second reel 102B, a third reel 102C, a fourth reel 102D, and a fifth reel 102E. In this example, each reel has four displayed positions, including a top position 104A, a top-center position 104B, a bottom-center position 104C, and a bottom position 104D (as viewed from top to bottom). Thus the array is a 5×4 array with five columns (i.e., five reels 102A-102E) and four rows (i.e., four positions 104A-104D).

Each array position is populated, upon spinning and stopping of the reels 102A-102E, with a respective symbol (although, in some embodiments, blank reel symbols may also be utilized which may result in one or more array positions being void of a symbol after the reels have stopped). In the illustrated example, which illustrates a wagering game in which a bonus-enhancement is determined based on a number of accrued symbols, the symbols include a plurality of symbol categories, including trigger symbols and non-trigger symbols. In this example, the non-trigger symbols further include additional categories of symbols, including, e.g., high symbols, mid symbols, and basic symbols. For example, the illustrated example includes at least one trigger symbol T (e.g., fifth reel 102E, bottom-center position 104C), one or more high symbols (e.g., K, Q, J, M, and N symbols), one or more mid symbols (e.g., 9 and 10 symbols), and one or more basic symbols (e.g., 1, 2, 3, and 4 symbols). Each category of symbols has a respective associated function, as explained in more detail below.

The trigger symbol T is a specific symbol and/or is required to land in a specific position. For example, in the wagering game example of FIG. 4, the trigger symbol T is a “siren” symbol that lands anywhere on the fifth reel 102E. In other examples, the wagering game is triggered in response to two or more trigger symbols T landing anywhere on the reels 102A-102E.

The game screen 100 further includes a multiplier indicator 106, which is currently illustrated at a default value of 1×; a payline indicator 108, which is currently illustrated to show 50 selected paylines; a bet-per-payline indicator 110, which is currently illustrated to show $0.01 bet per two paylines; a total bet indicator 112, which is currently illustrated to show a total bet of $0.25; and a win indicator 114, which is currently illustrated without any winning amount. Additional and/or alternative indicators can be used for illustrating other aspects of the wagering game.

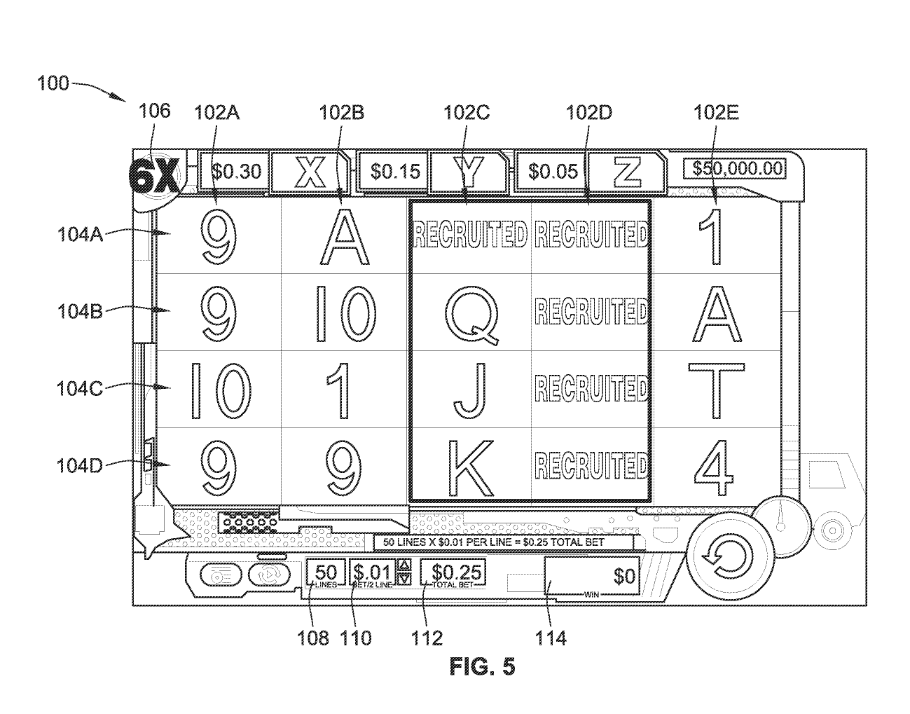

Referring to FIG. 5, the trigger symbol T has triggered a bonus game in which high symbols K, Q, J, M, and N symbols are accrued for determining a bonus enhancement, such as a value of a multiplier. Each high symbol is accrued to increase the multiplier 106 by 1×. As such, the default multiplier of 1× has now increased to 6×, because five symbols have been accrued (or “RECRUITED”). The five symbols include the symbol in the top position 104A of the third reel 102C, and all four symbols in the fourth reel 102D. In this example, the high-symbol category (e.g., a first category of non-trigger symbols) determines the bonus enhancement. In other examples, other symbols and/or categories determine the bonus enhancement.

In addition, the game screen 100 illustrates three different values X, Y, and Z for determining an initial award. The values X, Y, and Z are displayed above the reels 102A-102E, with each value X, Y, and Z being a dynamic value with respect to a player's bet. In this example, value X is $0.30, value Y is $0.15, and value Z is $0.05.

Upon accruing a required number of the first-category symbols (e.g., the high symbols) for determining the bonus enhancement, a value is selected from the different values X, Y, and Z, with the selected value being the value associated with each symbol of a second category (e.g., the mid symbols). As discussed in more detail below, the aggregated value of each second-category symbol determines an initial award to which the bonus enhancement is applied for providing a final award.

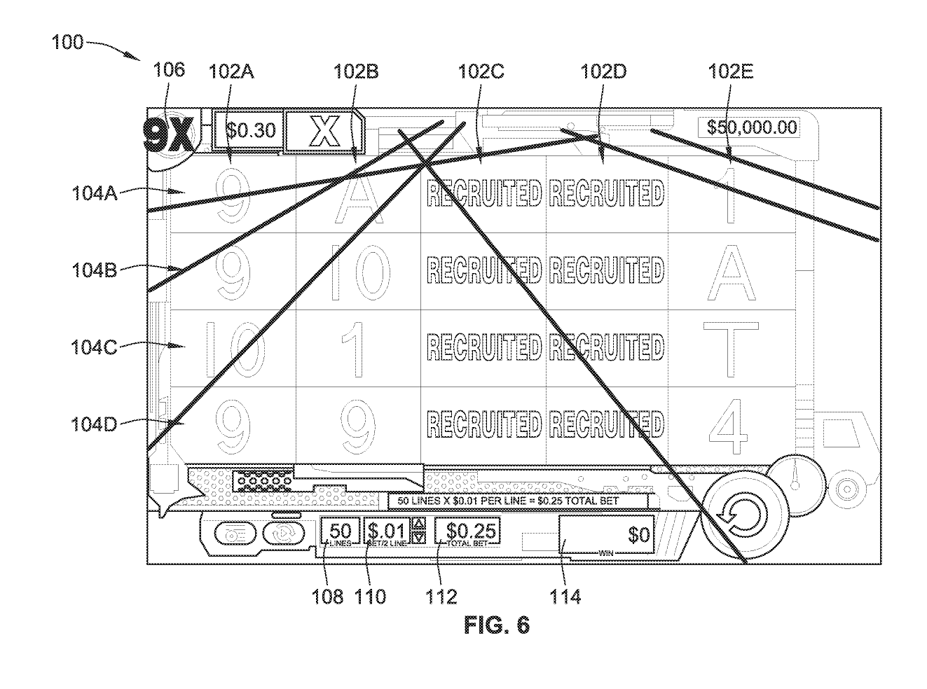

Referring to FIG. 6, the game screen 100 illustrates that a total of eight high symbols have been accrued—the four symbols designated now as “RECRUITED” in the third reel 102C and the four symbols designated now as “RECRUITED” in the fourth reel 102D. In accordance with the eight accrued high symbols, the multiplier 108 has increased to 9× (1× being the default multiplier, and 1× being added for each accrued high symbol).

According to this example, the eight accrued high symbols represent the total number required for selecting a value from the different values X, Y, and Z. The selection of the value, which can be a random selection or a player selection, determines that value X is the chosen value. In this example, the unselected values Y and Z are removed from view on the game screen 100 to leave value X as the selected value for a player's ease of understanding.

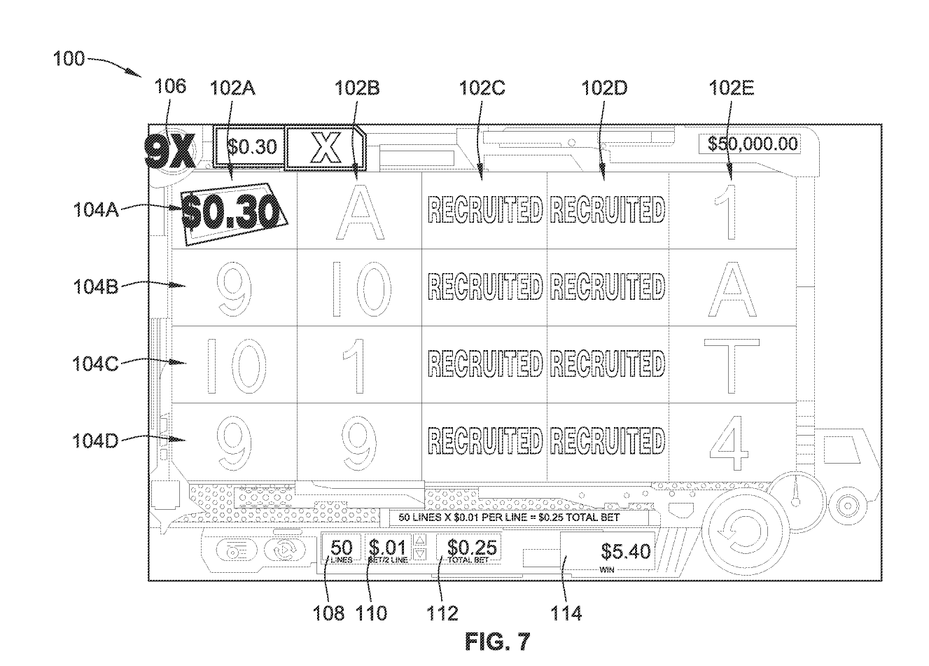

Referring to FIG. 7, after determining that the selected value is value X, the values of all mid symbols 9, 10, and A are aggregated. The selected value X is applied to each of the mid symbols. For example, a value of $0.30 is applied to and illustratively overlaid over symbol 9 in the top position 104A of the first reel 102A. As discussed below, the aggregated value of each mid symbol is paid to the player after being enhanced by the bonus enhancement. In this example, the value of the high symbols is greater than the value of the mid symbols. However, in other examples, the value of the high symbols can be smaller or equal to the value of the mid symbols.

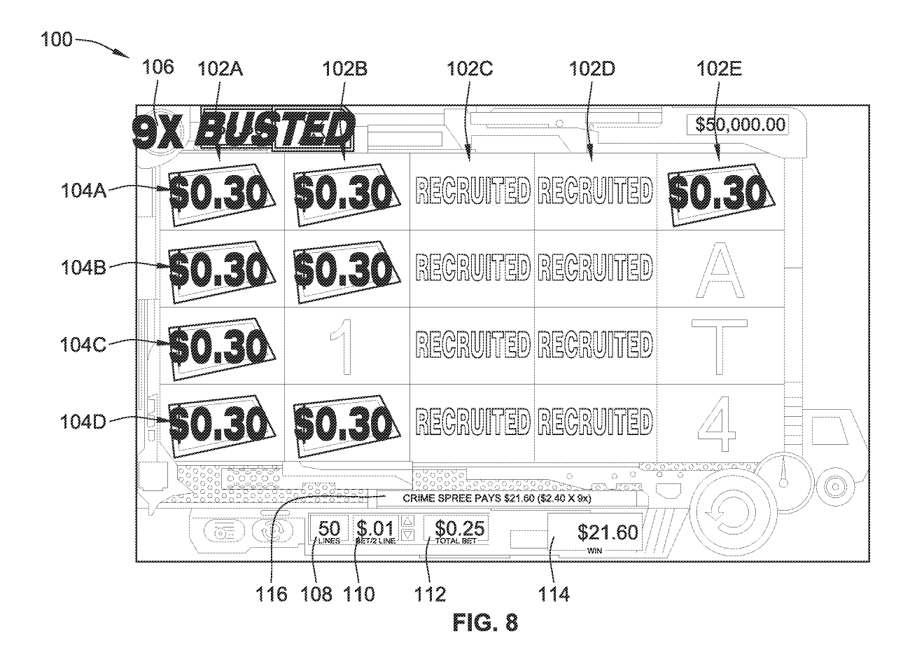

Referring to FIG. 8, a total of eight mid symbols are accrued—four mid symbols in the first reel 102A, three mid symbols in the second reel 102B, and one mid symbol in the fifth reel 102E. As such, the initial award is $2.40, which represents the aggregated value of 8 mid symbols, with each mid symbol having a value of $0.30. The multiplier 108 of 9× multiplies the collected value of $2.40 for a final award of $21.60 ($2.40×9×), as illustrated in a final award indicator 116. The final award of $21.60 is paid to the player.

Optionally, the bonus enhancement is displayed as being applied individually to each of the mid symbols, instead of being applied to the aggregated value. In other words, for example, the multiplier 108 of 9× is applied to each one of the eight mid symbols to display a value $2.70 superimposed over each mid symbol. The aggregated value of the eight enhanced symbols is still equal to a final award of $21.60.

### Alternative Bonus Enhancements

In alternative embodiments, the multiplier 106 can be, instead, a different type of bonus-award enhancement. For example, upon successfully collecting a threshold N amount of non-trigger symbols (which, for example, can be a maximum number of high symbols or a lower number than the maximum number of high symbols), one or more of the following enhancements occur: a free-spin award is provided to the player; the bonus game is triggered automatically (without requiring the trigger symbol T); the bonus game is triggered upon initiation by the player; the number of collected non-trigger symbols are added to the bonus game; etc.

### Pay Table

According to a feature of the wagering game, one or more of the non-trigger symbols, including the high symbols, the mid symbols, and the basic symbols, have an associated paytable value. For example, referring to FIG. 5, the high symbol Q in the third reel 102C, top-center position 104B, has an associated paytable value when playing a basic game. As such, the value of the high symbol Q pays in accordance with a paytable combination (e.g., three Q symbols in a row on an active payline pays $1.00) and the number of accrued high symbol Q determines a bonus enhancement (e.g., determines the value of the multiplier).

### Gameplay

According to another feature of the wagering game, the bonus game includes one or more of a free-spin event, a picking game, a progressive level game, a keno game, etc. For example, the bonus game includes a series of ten free spins in which the number of accrued non-trigger symbols (e.g., 10 high symbols accrued over the totality of spins) determines the value of a bonus multiplier enhancement (e.g., 11× multiplier). Assuming that the accrued award over the totality of the ten free spins is $10.00, the player would receive a total of $110.00 as the final award.

### Social Aspect

According to another alternative feature of the wagering game, the bonus game includes a social aspect in which both monetary and virtual benefits are awarded to a player. For example, if an N number of non-trigger symbols is accrued, the player receives virtual currency (e.g., player points) for redemption in accordance with established social rules. Thus, the accumulation of the non-trigger symbols provides simultaneous benefits (e.g., virtual currency) in addition to determining bonus enhancements (such as determining the value of the “Gang” multiplier 106).

### Pick Bonus

According to another alternative feature of the wagering game, the bonus game includes a pick bonus in which a trigger symbol T is populated in the first reel 102A and a plurality of “Royal” symbols are populated in other positions of the array. The number of all “Royal” symbols is counted, with the number of types of “Royal” symbols determining the number of picks and the number of each type of “Royal” determining the multipliers. According to a specific example, the greater the number of types of “Royal” symbols, the greater the number of picks. For example, one or more Q symbols results in a single pick, one or more of at least one Q symbol and at least one K symbol results in three picks, one or more of at least one Q symbol, at least one K symbol, and at least on A symbol results in five picks, etc. Optionally or alternatively, the number of each type of symbol affects the number of picks, as well. For example, one Q symbol results in a single pick, two Q symbols results in three picks, etc.

In addition to determining pick numbers, the number of “Royal” symbols are accrued to determine a respective multiplier. For example, a single Q or K symbol determines that the multiplier is 1×, two Q or K symbols determines that the multiplier is 3×, three Q or K symbols determines that the multiplier is 5×, five Q or K symbols determines that the multiplier is 10×, etc. Then, the multiplier is applied to the value of a picked award. Optionally, instead of or alternative to “Royal” symbols, the symbols for determining the bonus enhancements can be any symbols.

### Free Spin Bonus

Alternatively, instead of a pick bonus as discussed above, the bonus game includes a free spins game in which the player receives free spins instead of picks. Accordingly, the type of “Royal” symbols determines the number of free spins. For example, one or more Q symbols results in a single free spin, one or more of at least one Q symbol and at least one K symbol results in three free spins, etc. Optionally, the symbols become wilds during the free spins. In other words, each of the one or more Q symbols become wild symbols during the single free spin, each of the one or more of at least one Q symbol and at least one K symbol become wild symbols during the three free spins, etc.

### Progressive Triggering Condition

In another alternative feature, the bonus game includes a progressive triggering condition. For example, a first number of J symbols are collected to trigger a J progressive, a second number of Q symbols are collected to trigger a Q progressive, etc. The number of a specific type of collected symbols is used as the threshold for triggering a respective progressive event, and the threshold values may be the same variable for the various progressive awards.

### Symbol Association

In another alternative feature, the bonus game includes associated symbols that result in a different award than unassociated symbols. For example, a number of J symbols are representative of gold bars. Upon triggering the bonus game, the J symbols are accrued to determine the bonus enhancement (such as increasing a multiplier). A subsequent triggering condition or selection determines a selection between a “Gold Thief” and a “Jewel Thief.” For example, instead of randomly selecting a “Gang Leader” as described above, a random selection determines that the gold bars belong to the “Gold Thief” The value of the gold bars will be greater if the “Gold Thief” is selected than if the “Jewel Thief” is selected. For example, three J Symbols result in a 6× multiplier if the “Gold Thief” is selected and a 4× multiplier if the “Jewel Thief” is selected. In other words, each J symbol in this example is worth twice with the “Gold Thief” than with the “Jewel Thief.”

### Surrounding Symbols

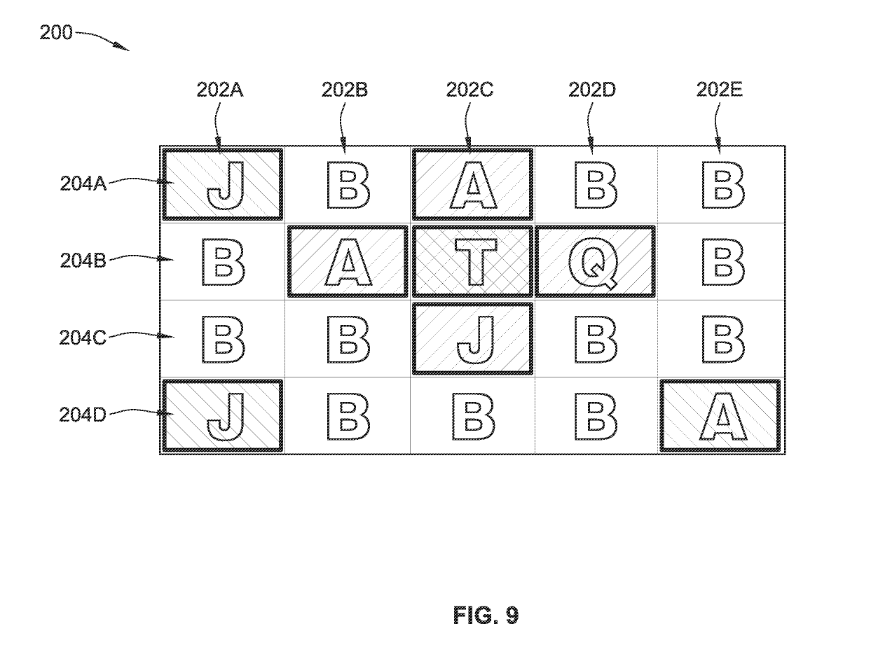

In another alternative feature, referring to FIG. 9, the bonus game includes having surrounding (or adjacent) symbols of a trigger symbol that provide an additional benefit to the player. For example, the trigger symbol T is generally in the center of an array 200 (e.g., third reel 202C, top-center position 204B) with special surrounding symbols A above the trigger symbol T (i.e., third reel 202C, top position 204A) and J below the trigger symbol T (i.e., third reel 202C, bottom-center position 204C). The rest of the reel positions are populated with basic symbols B. Upon triggering the bonus game, each non-surrounding A and J symbol (e.g., a J symbol in a first reel 202A, top position 204A) increases the multiplier by 1×, but each surrounding A and J symbol increases the multiplier by 3×.

Thus, an additional benefit is for the trigger symbol T to land in a central position on the array, which maximizes the likelihood of having the most surrounding symbols. In contrast, a marginal position, such as in the top position 204A of the first reel 202A minimized the likelihood of having the most surrounding symbols.

In another alternative feature, referring to the above example, it is further assumed that the trigger symbol T is further surrounded on the left side with a special surrounding symbol A (i.e., second reel 202B, top-center position 204B) and on the right side with a special surrounding symbol Q (i.e., fourth reel 202D, top-center position 204B). The bonus game pays mixed at the highest level of the highest surrounding symbol. Assuming that each symbol A is associated with a 3× multiplier increase, each symbol J is associated with a 1× multiplier increase, and each symbol Q is associated with a 2× multiplier increase, the bonus optionally pays at 6× multipliers (based on the two symbols A, each paying at 3× multiplier).

### Bingo

In another example, the bonus game includes a bingo game in which already daubed numbers provide a special prize if a special ball is drawn. In other words, the daubed numbers serve their traditional purpose in which they are used to form a specific pattern for a winning combination. In addition to the traditional purpose, the daubed numbers are counted to provide a special prize if a triggering condition occurs. For example, the triggering condition is a special number that is drawn. If the special number is drawn, the accumulation of daubed numbers (or certain daubed numbers) results in the special prize.

### Poker

In another example, the bonus game includes a poker game in which the number of certain type of cards is accrued to provide a special award. For example, if a trigger Ace of Spades card is drawn by the player, all the Spades cards are counted to provide the special award.

### Multi Arrays

In another example, the bonus game includes multi-arrays in which a trigger symbol is achieved in a first array and special symbols are counted in other arrays to determine a bonus enhancement. The arrays can be cascading arrays in which the game pays as a normal line but also collects for a bonus award upon a triggering condition.

Optionally, each of the arrays is counted differently. For example, a multi-array wagering game includes a first array, a second array, a third array, and a fourth array. The trigger symbol occurs in the first array, the high symbols occur in the second array, the mid symbols occur in the third array, and the basic (or low) symbols occur in the fourth array. As such, the first array determines if the triggering condition occurs for the bonus game. The second array determines the number of high symbols based on which the bonus enhancement (e.g., multiplier) is determined. The third array determines the initial collected award value. The fourth array has no effect on the bonus game.

In another example of multi-arrays, a multi-array includes a left array, a center array, and a right array. The trigger symbol T occurs in the center array. Special symbols J in the left array count towards a multiplier and special symbols A in the right array count towards a bonus award. In other words, an accrued number of a specific type of symbols in a particular array determines a specific bonus enhancement.

In a further example of multi-arrays, the bonus game includes Colossal Reels in which a threshold number on main reels affect additional sets of reels. According to one example, the Colossal Reels includes a standard set of five reels and a smaller set of five reels, which plays in tandem with the standard reels. Upon triggering a bonus game on the standard reels, special symbols A count towards a bonus enhancement (e.g., a bonus multiplier). If a threshold is reached, e.g., five symbols A are accrued on the standard reels, special symbols A on the smaller set of reels are also counted. Thus, in addition to the bonus trigger by a symbol such as symbol T, a trigger threshold of N symbols A is required on the standard reels to activate further accumulation of symbols A on an additional set of reels.

In another example of the Colossal Reels, upon reaching a threshold count of symbols A on the standard reels, all symbols A on the additional set of reels receive a different function. For example, if five symbols A land on the standard reels, all symbols A on the additional set of reels become wild symbols.

Trigger with Qualifying Condition

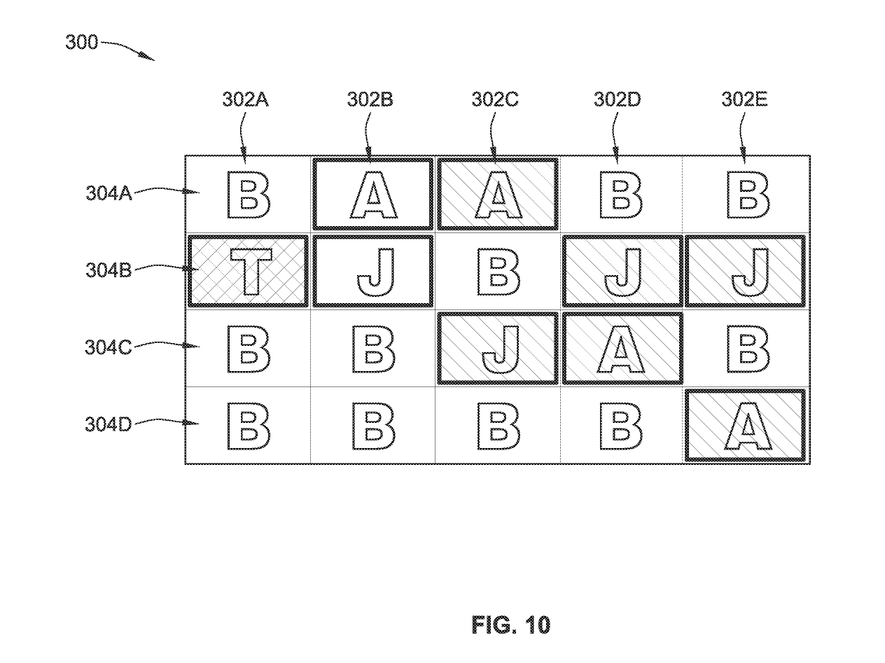

In another example, referring to FIG. 10, the bonus game includes both a trigger condition and a qualifying condition. For example, the trigger symbol T lands in a first reel 302A of a reel array 300. If the trigger symbol T occurs in the first reel 302A, at least some of the symbols that land in a second reel 302B become qualifying symbols that are counted towards determining a bonus enhancement. For example, the qualifying symbols of the second reel 302B are A and J symbols in this example.

Any A and J symbols that land in a third reel 302C, a fourth reel 302D, or a fifth reel 302E are accrued to determine a bonus enhancement. In the illustrated example, a total of six A and J symbols have landed in the last three reels 302C-302E. Optionally, if N number of A and J symbols land in the last three reels 302C-302E, player receives a level of a progressive game. Assuming that N is five symbols, the player receives a progressive game in the illustrated bonus game of FIG. 10.

### Highest Accrued Number

In another example, the bonus game includes a feature in which the highest accrued number of two or more different types of non-trigger symbols determines which bonus feature is awarded to the player. For example, upon triggering the bonus game, high symbols include A, J, and Q symbols. If the A symbols include three A symbols, the J symbols include two J symbols, and the Q symbols include a single Q symbol, the bonus feature is determined to be an A bonus game (instead of a J bonus game or a Q bonus game). In other words, each of the three different types of symbols is associated with a respective bonus feature (e.g., a bonus game, a multiplier, etc.). The highest number of accrued symbols of a specific type determines the bonus feature.

Optionally, if the number of high symbols includes the same number of two or more types of symbols, the player receives each of the respective bonus features associated with those two or more types of symbols. For example, if the A symbols include three A symbols, the J symbols include three J symbols, and the Q symbols includes three Q symbols (i.e., a three-way tie), the player receives all three bonus games—the A bonus game, the J bonus game, and the Q bonus game.

### Negative Effect

In another example, the bonus game includes a feature in which symbols have an adverse effect on an award. For example, upon triggering the bonus game, each symbol of a certain type decreases the value of a base award. By way of a more specific example, the trigger symbol T lands in the first reel 102A and, in response, the player is awarded $1,000. However, for every J symbol that lands in the remaining reels 102B-102E, the award of $1,000 is decreased by a certain percentage (e.g., each J symbol reduced the award by 50%).

### Cliff Hanger

Optionally, the bonus game includes a cliff hanger feature in which varied positive and negative effects result based on the achieved symbols. For example, upon triggering the bonus game, three J symbols are received. The first J symbol provides no enhancement, the second J symbol provides an enhancement (e.g., $1,000), and the third J symbol eliminates the enhancement (e.g., reduces the $1,000 to $0).

### Trail Feature

In another example, the bonus game includes a trail feature in which accumulation of special symbols result in movement on a trail. For example, upon receiving the trigger symbol T the player receives two high symbols Q and three high symbols K. In response, the player advances two positions on a trail Q (based on the two high symbols Q) and three positions on a trail K (based on the three high symbols K). Thus, each count (i.e., each symbol) is a move on the respective trail. When the top of the trail is reached, the trail is reset.

Optionally or alternatively, accrued symbols cause adverse movement on the trail, away from the goal of reaching the end of the trail. For example, an odd number of symbols Q cause movement in a forward direction, but an even number of symbols Q cause movement in a backwards direction. In another example, the symbols Q are further defined into positive symbols Q1 and negative symbols Q2. In this example, the count of the positive symbols Q1 cause advancement on the trail, but the count of the negative symbols Q2 cause retreating on the trail.

### Pick Special Symbols

In another example, the bonus game includes a feature in which a player picks the special symbols that affect the bonus enhancement. For example, before spinning a reel, player input is requested to select which symbols are counted towards increasing a bonus multiplier. The player may select symbols A, instead of symbols J. Accordingly, upon triggering the bonus game and spinning the bonus spin, each symbol A is counted to determine the bonus multiplier.

### Count Affects Functionality

In another example, the bonus game includes a feature in which the number of symbols affects the function of the symbols. For example, a single symbol A will function solely as a regular payable symbol, two symbols A will function as wild symbols (in addition to the regular paytable function), three symbols A will function as multiplier symbols (in addition to the regular paytable function), etc.

In yet another example, a single symbol A will count as a 1× multiplier, but two symbols A will each count as 2× multipliers (i.e., for a total 4× multiplier). Thus, the bonus function of the symbols, upon triggering the bonus game, varies as a function of the number of the symbols.

In a further example, a threshold count changes the symbols from one type to another type. For example, one single symbol A functions as a default symbol A, but two symbols A function as two symbols K (assumingly, the symbols K having a more favorable function than symbols A).

### Probability

In another example, the bonus game includes a probability feature in which the number of symbols affects the probability of receiving a game outcome. For example, the greater the number of symbols A, the greater the probability that a next game outcome will be a winning outcome.

### Next Spin

In another example, the bonus game includes a next outcome feature in which the number of symbols affects a next game outcome. For example, if five symbols A land on the reels 102A-102E during a first spin, each symbol A that lands on the reels 102A-102E in a second spin becomes a wild symbol. Optionally, the first and second spin are successive spins of a plurality of free spins.

Optionally yet, the position of the symbols A can further affect the functionality of the symbols. For example, if five symbols A land only on the first and second reels 102A, 102B, only symbols A that land in the first and second reels 102A, 102B of the second spin become wild symbols (or affect a bonus enhancement).

### Array Sections

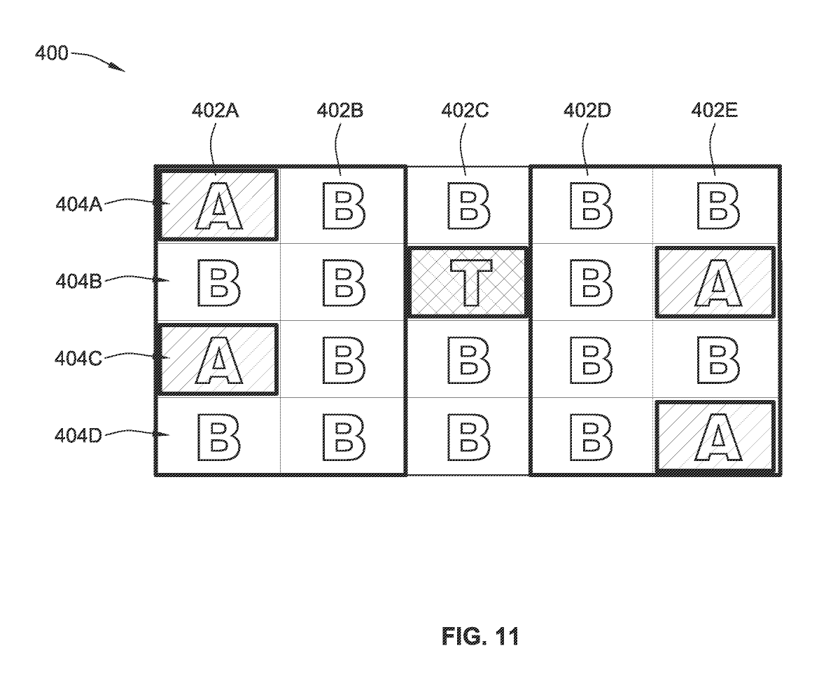

In another example, referring to FIG. 11, the bonus game includes an array 400 in which a bonus enhancement is determined based on the number of symbols in a specific array section. For example, a trigger symbol T lands on a third reel 402C, in a top-center position 402B. The array 400 is further populated with non-trigger symbols that include basic symbols B and special-count symbols A. The number of any symbols A that land on a left side of the array, i.e., on a first reel 402A or second reel 402B, determine a bonus multiplier. The number of any symbols A that land on the right side of the array, i.e., on a fourth reel 402D or fifth 402E, determine a collected award.

By way of further example, two symbols A landing on the first reel 402A are valued at 1× multiplier each and contribute to providing a cumulative 3× multiplier (1× default multiplier+1× first symbol A multiplier+1× second symbol A multiplier). Two symbols A landing on the fifth reel 402E are valued at $1 each for a total collected award of $2 ($1 for the First symbol A and $1 for the second symbol A). The total award paid to the player will be $6 (3× multiplier x $2).

### Multiple Trigger Symbols

Optionally, the bonus game includes multiple trigger symbols, each of the trigger symbols triggering a specific, simultaneous bonus feature. For example, a first trigger symbol triggers a first bonus feature in which any symbols A that are adjacent to the first trigger symbol are counted towards a bonus multiplier. A second trigger symbol triggers a second bonus feature in which any symbols A that are adjacent to the second trigger symbol are counted towards a collected award. In one example, the multiple triggers occur in the same array. In another example, the multiple triggers occur in multiple arrays (e.g., the first trigger occurs in a first array and the second trigger occurs in a second array).

### Mega Symbol

In another example, the bonus game includes a feature in which a plurality of free spins include at least one mega symbol. For example, upon having a triggering symbol T land on one of the reels, any symbol of which you have at least two symbols becomes a mega symbol. The greater the number of symbols, the greater the mega symbol. By way of a specific example, two A symbols become a 2×2 square of A symbols on the reels, five A symbols become a 5×5 square of A symbols on the reels, etc. The mega symbol is applied to a subsequent spin in a plurality of free spins.

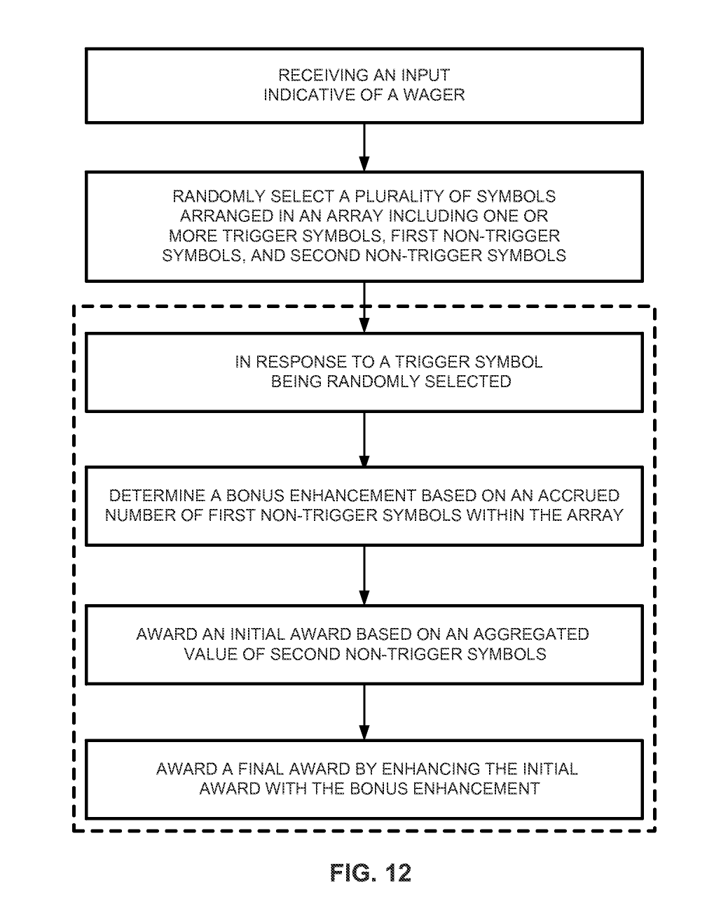

FIG. 12, described by way of example above, represents one algorithm that corresponds to at least some instructions stored and executed by the game-logic circuitry 28 in FIG. 2 to perform the above described functions associated with the disclosed concepts.

Each of these embodiments and obvious variations thereof is contemplated as falling within the spirit and scope of the claimed invention, which is set forth in the following claims. Moreover, the present concepts expressly include any and all combinations and subcombinations of the preceding elements and aspects.

What is claimed is:

1. A gaming system comprising:
a gaming machine primarily dedicated to playing at least one casino wagering game, the gaming machine including a gaming cabinet, an electronic display device, and one or more electronic input devices, the electronic display device and the one or more electronic input devices being coupled to the gaming cabinet, at least one of the one or more electronic input devices configured to detect a physical item associated with a monetary value that establishes a credit balance, at least one of the one or more electronic input devices configured to receive a cashout input that initiates a payout from the credit balance, the credit balance changing based on play of the casino wagering game; and
game-logic circuitry configured to:
initiate the casino wagering game in response to a wager input, the wager input decreasing the credit balance,
randomly select a plurality of symbols arranged in an array, the array including at least one trigger symbol and a plurality of non-trigger symbols, the plurality of non-trigger symbols including one or more first non-trigger symbols and one or more second non-trigger symbols;
direct the electronic display device to display the array; and
in response to the at least one trigger symbol being randomly selected,
determine a bonus enhancement based on an accrued number of the first non-trigger symbols within the array,
award an initial award based on an aggregated value of the second non-trigger symbols, and
award a final award by enhancing the initial award with the bonus enhancement.

2. The gaming system of claim 1, further including a random element generator configured to generate one or more random elements, the plurality of symbols being randomly selected based, at least in part, on the one or more random elements.

3. The gaming system of claim 2, wherein the random element generator and the game-logic circuitry reside within the gaming cabinet.

4. The gaming system of claim 1, wherein the game-logic circuitry is further configured to select an individual value for each of the second non-trigger symbols, the aggregated value being a total of the individual values of the second non-trigger symbols.

5. The gaming system of claim 4, wherein the game-logic circuitry is further configured to select the individual value in response to a predetermined number of first non-trigger symbols being accrued.

6. The gaming system of claim 4, wherein the game-logic circuitry is further configured to randomly select the individual value from a plurality of individual values.

7. The gaming system of claim 4, wherein the game-logic circuitry is further configured to receive a player selection to select the individual value from a plurality of individual values.

8. A method of operating a gaming system, the gaming system including game-logic circuitry and a gaming machine, the gaming machine primarily dedicated to playing at least one casino wagering game, the gaming machine including a gaming cabinet, an electronic display device, and one or more electronic input devices, the electronic display device and the one or more electronic input devices being coupled to the gaming cabinet, the method comprising:
detecting, via at least one of the one or more electronic input devices, a physical item associated with a monetary value, the monetary value establishing a credit balance that changes based on play of the casino wagering game;
receiving, via at least one of the one or more electronic input devices, a wager input to initiate the casino wagering game, the wager input decreasing the credit balance;
randomly selecting, by the game-logic circuitry, a plurality of symbols arranged in an array and including at least one trigger symbol and a plurality of non-trigger symbols, the plurality of non-trigger symbols including one or more first non-trigger symbols and one or more second non-trigger symbols;
displaying the array on the electronic display device;
in response to the at least one trigger symbol being randomly selected,
determining, by the game-logic circuitry, a bonus enhancement based on an accrued number of first non-trigger symbols within the array,
awarding, by the game-logic circuitry, an initial award based on an aggregated value of the second non-trigger symbols, and
awarding, by the game-logic circuitry, a final award by enhancing the initial award with the bonus enhancement; and
receiving, via at least one of the one or more electronic input devices, a cashout input that initiates a payout from the credit balance.

9. The method of claim 8, further comprising selecting, by the game-logic circuitry, an individual value for each of the second non-trigger symbols, the aggregated value being a total of the individual values of the second non-trigger symbols.

10. The method of claim 9, further comprising selecting, by the game-logic circuitry, the individual value in response to a predetermined number of first non-trigger symbols being accrued.

11. The method of claim 9, further comprising randomly selecting, by the game-logic circuitry, the individual value from a plurality of individual values.

12. The method of claim 9, further comprising receiving, by the game-logic circuitry, a player selection to select the individual value from a plurality of individual values.

13. The method of claim 8, wherein the bonus enhancement is a multiplier, the multiplier increasing with each first non-trigger symbol.

14. The method of claim 8, wherein the aggregated value is a credit value and the bonus enhancement is selected from a group consisting of a multiplier, a credit award, a free spin, and a pick.

15. A casino gaming machine primarily dedicated to playing at least one casino wagering game, comprising:
a gaming cabinet;
an electronic display device coupled to the gaming cabinet;
one or more electronic input devices coupled to the gaming cabinet, at least one of the one or more electronic input devices configured to detect a physical item associated with a monetary value that establishes a credit balance, at least one of the one or more electronic input devices configured to receive a cashout input that initiates a payout from the credit balance, the credit balance changing based on play of the casino wagering game; and
game-logic circuitry disposed within the gaming cabinet and configured to:
initiate the casino wagering game in response to a wager input, the wager input decreasing the credit balance,
randomly select a plurality of symbols arranged in an array and including at least one trigger symbol and a plurality of non-trigger symbols, the plurality of non-trigger symbols including one or more first non-trigger symbols and one or more second non-trigger symbols,
direct the electronic display device of the gaming machine to display the array, and
in response to the at least one trigger symbol being randomly selected,
determine a bonus enhancement based on an accrued number of first non-trigger symbols within the array,
award an initial award based on an aggregated value of the second non-trigger symbols, and
award a final award by enhancing the initial award with the bonus enhancement.

16. The gaming machine of claim 15, further including a random element generator configured to generate one or more random elements, the plurality of symbols being randomly selected based, at least in part, on the one or more random elements.

17. The gaming machine of claim 15, wherein the game-logic circuitry is further configured to select an individual value for each of the second non-trigger symbols, the aggregated value being a total of the individual values of the second non-trigger symbols.

18. The gaming machine of claim 17, wherein the game-logic circuitry is further configured to select the individual value in response to a predetermined number of first non-trigger symbols being accrued.

19. The gaming machine of claim 17, wherein the game-logic circuitry is further configured to select the individual value from a plurality of individual values.

20. The gaming machine of claim 17, wherein the game-logic circuitry is further configured to receive a player selection to select the individual value from a plurality of individual values.
